(19) United States
(12) Patent Application Publication
(10) Pub. No.: US 2020/0364638 A1
(43) Pub. Date: Nov. 19, 2020

(54) AUTOMATED INFORMATION TECHNOLOGY (IT) PORTFOLIO OPTIMIZATION

(71) Applicant: International Business Machines Corporation, Armonk, NY (US)

(72) Inventors: Christopher L. MOLLOY, Research Triangle Park, NC (US); Christopher J. DAWSON, Herndon, VA (US); Craig M. TRIM, Glendale, CA (US); John M. GANCI, JR., Durham, NC (US)

(21) Appl. No.: 16/411,877

(22) Filed: May 14, 2019

(51) Int. Cl. G06Q 10/06; G06Q 10/04; G06Q 10/10; G06F 17/28; G06N 20/00; H04L 12/24

(52) U.S. Cl. CPC G06Q 10/0637; G06Q 10/06316; G06Q 10/04; H04L 41/5006; G06F 17/28; G06N 20/00; G06Q 10/103

(57) ABSTRACT

Methods, computer program products, and systems are presented. The methods include, for instance: collecting inputs of relevant contracts and invoices from one or more information technology (IT) service systems. Information on one or more IT services and one or more IT resources corresponding to an IT service of the one or more IT services is extracted from the inputs. An IT service system provisions the IT service to an IT client by using the one or more IT resources. A capacity demand in a timeframe on an IT resource is forecasted based on the information from the extracting. A solution to procure an item that meets the forecasted capacity demand is selected and optimized IT portfolio including the item and the solution is produces to optimize an IT portfolio.

### TECHNICAL FIELD

The present disclosure relates to IT portfolio management, and more particularly to methods, computer program products, and systems for automating and optimizing IT portfolio management.

### BACKGROUND

Conventional IT portfolio management is defined as an effort to apply a systematic management method to the investments of an enterprise on IT related projects and activities, to gain the most benefit from the IT investments. IT activities, regardless of whether or not the IT activities are revenue making services for clients or projects to optimize operations of the enterprise, are significant in success of business activities by the enterprise and its significance grows with new and advanced technological environment of today. An IT portfolio of an enterprise is a repository for all IT assets and undertakings that consumes the IT assets. The conventional IT portfolios would represent items such as planned initiatives, projects, ongoing IT services including application support, and resources corresponding to respective undertakings. Conventional IT portfolio management attempts to quantify previously informal IT efforts of the enterprise and to respond to the needs thereof in a certain standard procedure, to objectively measure performances of the IT efforts in terms of cost-effectiveness.

### SUMMARY

The shortcomings of the prior art are overcome, and additional advantages are provided, through the provision, in one aspect, of a method. The method includes, for instance: collecting, by one or more processor, inputs from one or more information technology (IT) service systems, where the inputs include one or more service level agreements (SLAs), one or more SLA invoices corresponding to the one or more SLAs, one or more underpinning contracts (UCs), and one or more UC invoices; extracting, by the one or more processor, information on one or more IT services and one or more IT resources corresponding to an IT service of the one or more IT services from the inputs, where an IT service system of the one or more IT service systems provisions the IT service to an IT client by using the one or more IT resources; forecasting, by the one or more processor, a capacity demand in a timeframe on an IT resource of the one or more IT resources based on the information from the extracting; selecting, by the one or more processor, an optimal procurement solution for an item of the IT resource that satisfies the capacity demand; and producing, by the one or more processor, an optimized IT portfolio comprising the item of the IT resource and the optimal procurement solution.

Additional features are realized through the techniques set forth herein. Other embodiments and aspects, including but not limited to computer program products and systems, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for optimizing an information technology (IT) portfolio, in accordance with one or more embodiments set forth herein;

FIG. 2 depicts elements of the IT service system, in accordance with one or more embodiments set forth herein;

FIG. 3 depicts detailed operations of the IT portfolio optimization engine, in accordance with one or more embodiments set forth herein;

FIG. 4 depicts an exemplary data flow for the IT portfolio forecasting model, in accordance with one or more embodiments set forth herein;

FIG. 5 depicts a cloud computing node according to an embodiment of the present invention;

FIG. 6 depicts a cloud computing environment according to an embodiment of the present invention; and

FIG. 7 depicts abstraction model layers according to an embodiment of the present invention.

### DETAILED DESCRIPTION

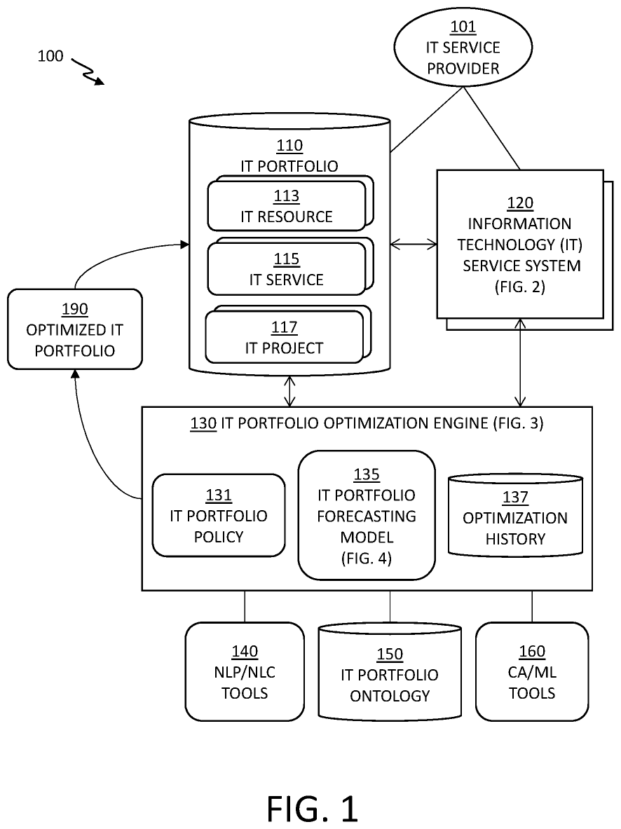

FIG. 1 depicts a system 100 for optimizing an information technology (IT) portfolio 110, in accordance with one or more embodiments set forth herein.

Conventionally, IT portfolio management is a manual effort to apply a systematic management method to the investments, projects and activities of enterprise Information Technology (IT) departments, to gain the most benefit from the IT investments. The items represented in conventional IT portfolios would be planned initiatives, projects, ongoing IT services including application support, and resources corresponding to respective undertakings. Conventional IT portfolio management attempts to quantify previously informal IT efforts and to respond to the needs thereof in a certain standard procedure, to objectively measure performances of the IT efforts in terms of cost-effectiveness.

The system 100 includes the IT portfolio 110, an IT service system 120, and an IT portfolio optimization engine 130. The system 100 is run by an IT service provider 101, who is an entity that offers one or more IT services 115 that are described in the IT portfolio 110 to IT clients for a fee by use of the IT service system 120. The IT service provider 101 can operate more than one IT service system 120 in various locations in many countries. In an embodiment of FIG. 1, the IT portfolio 110 is a central repository that contains all elements controlled and managed by the IT service provider 101.

The IT service system 120 utilizes one or more IT resources 113, which are also described in the IT portfolio 110, in order to provision the one or more IT services 115 to the IT clients. One or more IT projects 117, which are also described in the IT portfolio 110, specifies operations in procuring the one or more IT resources 113 and in rendering the one or more IT services 115 in the IT service system 120.

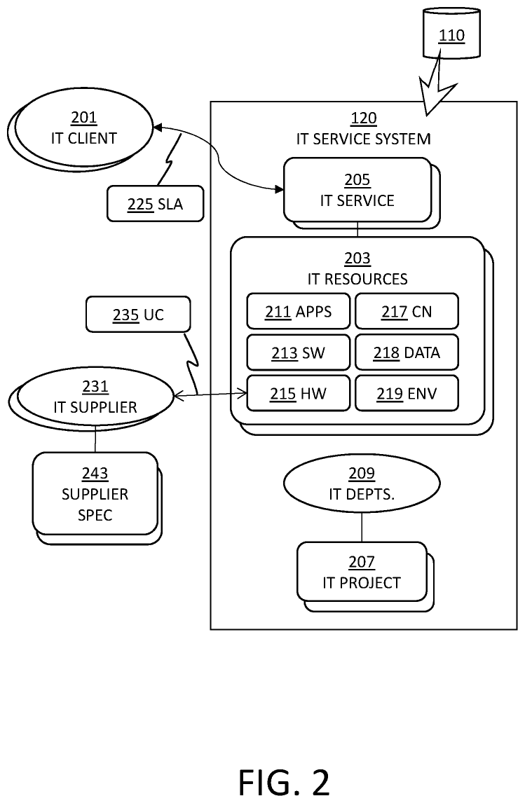

The one or more IT services 115 and the one or more IT projects 117 collectively indicate all IT undertaking that consumes IT resources, as performed by the IT service provider 101 across one or more IT service systems 120. In this specification, the term “IT service” indicates a set of IT functionalities that are commercially offered and provisioned for a fee to IT clients, which are often business entities. The one or more IT services 115 are provisioned according to a respective agreement between the IT service provider 101 and the IT clients that is often referred to as Service Level Agreement (SLA), specifying terms of how the IT service would be provisioned. Each of the one or more IT services 115 are described according to a set of certain elements as configured for the IT service system 120, which is referred to as a service description that includes both the utilities of the IT service, what the IT service does, and the non-functional aspects of the IT service, including, but not limited to, performance, payment, price, temporal availability and locative availability, obligations, rights, security, trust, quality, discounts, and penalties. Details of the IT service system 120 are presented in FIG. 2 and corresponding description.

As noted, the IT portfolio 110 includes the all resources and undertakings of the IT service system 120 that utilizes the resources for. The resources of the IT service provider 101 as being described in the IT portfolio 110 include the one or more IT resources 113 indicating any purchased assets of the IT service system 120 such as hardware, software, network bandwidth, data, and system environment, as well as human resources. The undertakings of the IT service system 120 that utilizes the resources include the one or more IT services 115, the one or more IT projects 117, and any other administrative tasks.

Examples of the one or more IT services 115 include, but are not limited to: data service as in data processing, data analysis, and data visualization; content/knowledge management; media, network, and communication as in Internet Service Providers (ISPs); information security; artificial intelligence offerings based on cognitive analytics, natural language processing, and machine learning; business automation and transaction processing as in banking and financial transactions; application programming interfaces (APIs) and applications; systems, software, and development environments; cloud computing and cloud storages, and so on.

On the other hand, the term “IT project” indicates operations to facilitate the IT services 115 including, for example, updating and/or changing of IT capacity of the IT service provider 101 that is represented in the IT portfolio 110. Each of the IT projects 117 has information on respective charter, description, budget, schedule, performance and outlook. A project plan for the each of the IT projects 17 indicates a set of work plans, including management, human resource, technical environment, project quality, communication management, etc. Examples of the one or more IT projects 117 include, but are not limited to, evaluation of status of items of the one or more IT resources 113 in respective lifecycles, latest technological trends, and compatibility with other systems in provisioning the one or more IT services 115, procurement of respective items of the one or more IT resources 113 that have a remaining lifetime less than respective thresholds for each type of the IT resources 113, migration of IT service workloads to provision the one or more IT services 115 to a new set of IT resources 113, and ensuring continuity of IT services 115 based on terms of respective service level agreements (SLAs) while optimizing the IT service system 120. As the IT service system 120 provisions each IT service of the one or more IT services 115 as specified in applicable SLAs in aspects of, including, but not limited to, functionality, capacity, speed, bandwidth, continuity, availability with threshold downtime, and other performance metrics applicable under the SLAs, the IT portfolio optimization engine 130 monitors and extracts information on the IT services 115 and the IT resources 113 and relevant IT projects 117, respectively corresponding to the IT services 115, in order to produce the optimized IT portfolio 190.

The resources of the IT service system 120 include the one or more IT resource 113 of the IT portfolio 110, indicating any equipment or functionalities/capacity that had been procured including, but not limited to, hardware, devices, software, network bandwidth, and certain types of configuration information as well as human resources. In this specification, the one or more IT resources 113 are a part of IT assets of the IT service provider 101. The IT assets, or simply the assets, of the IT service provider 101 include anything that can directly or indirectly contribute to servicing the IT clients with the one or more IT services 115 offered by the IT service provider 101. Examples of the IT assets of the IT service provider 101, include, but not limited to, the entity of the IT service provider 101 as an organization, the infrastructure to operate and to provision IT services 115, financial assets as in credits and capital, rights with monetary values, equipment, process, management, knowledge, people, information, application.

The human resources of the IT service system 120 include IT personnel employed by the IT service provider 101. Third parties that supply one or more particular IT resource of the IT service system 120 would also contribute to the operations of the IT service system 120 as counterparts in procurements and requisition of the IT resources 113. Details of the respective resources of the IT service system 120 are presented in FIG. 2 and corresponding description.

The IT portfolio optimization engine 130 of the system 100 optimizes resources and operations of the IT service system 120 and other IT service systems of the IT service provider 101, if any. All of the resources and operations across one or more IT service system 120 of the IT service provider 101 are represented in the IT portfolio 110.

In certain embodiments of the present invention, the IT service provider 101 operates more than one IT service system separately in distinctive locations. The IT service provider 101 can benefit from centralizing or otherwise systematically organizing operations of these multiple IT service systems, particularly in more effective procurement of the IT resources such as lower unit prices and less licensing fees based on economies of scale, or keeping all resources of the IT service system coherently up-to-date across many locations.

The one or more IT projects 117 for the IT service system 120 as represented in the IT portfolio 110 describe internal processes and operations to facilitate and to support the one or more IT services 115. The IT portfolio optimization engine 130 automates the one or more IT projects 117 by processing information represented in the IT portfolio 110, as being available for the IT service provider 101 across all IT service systems of the IT service provider 101 including the IT service system 120.

The IT portfolio optimization engine 130 includes an IT portfolio policy 131, IT portfolio forecasting model 135, and an optimization history 137. The optimization history of the IT portfolio optimization engine 130 is a record of past optimization instances on the IT portfolio 110, which is a collection of the optimized IT portfolios 190 that had been produced by the IT portfolio optimization engine 130 in the past. The IT portfolio optimization engine 130 is operationally coupled to one or more natural language processing and natural language classification (NLP/NLC) tools 140, and IT portfolio ontology 150, and one or more cognitive analytics and machine learning (CA/ML) tools 160.

The IT portfolio optimization engine 130 processes documentations present in and around the IT service system 120 and extracts information by use of the NLP/NLC tools 140. The IT portfolio optimization engine 130 builds the IT portfolio forecasting model 135 based on the extracted information, contents of the IT portfolio 110, and other relevant information on technology trend, adoption curves and/or lifecycles of the IT resources 113 per type of the IT resources 113, by use of the IT portfolio ontology 150 and the CA/ML tools 160.

The IT portfolio ontology 110 defines variables appearing in the IT portfolio 110 and attributes corresponding to respective variables, including, but not limited to, a range of acceptable values for respective variable, a type of the variable, available options, subcategories and categories of the variables, cost, lifecycle, etc. For example, in the IT portfolio ontology 110, a variable “server” can be of a category “IT resource” and a subcategory “hardware” for a type of an IT resource, and have available options “{server-A, server-Q, server-E}”. Once inputs from the IT service system 120 are compiled with NLP/NLC tools 140 based on the framework of the IT portfolio ontology 110, the IT portfolio optimization engine 130 can specify aspects of “server” variable to respective specifications including processor type, physical dimensions, throughput, and clock speed, stages in lifecycle, prices, available locations, and suppliers for each available options “{server-A, server-Q, server-E}”.

In one embodiment of the present invention, the IT portfolio forecasting model 135 is a set of models per type of the IT resources 113, which respectively evaluates a current state of a subject type of the IT resources 113 based on the input documents and collected data, and models an optimal state of the subject type of the IT resources 113 at certain preconfigured points of time in the future, which can be a prospected growth period for the IT service 115, yearly changes on various technology trends for the subject type of the IT resources 113, projected times of regulatory changes affecting the subject type of the IT resources 113, a projected expiration date of a currently employed instances of the IT resources 113 of the subject type, and combinations thereof. The IT portfolio forecasting model 135 attempts to strategically optimize the IT portfolio 110 from the perspective of the IT service provider 101 encompassing all IT service systems 120, in terms of cost effectiveness of operations at an enterprise level based on various factors affecting the future state of the IT service systems 120 of the IT service provider 101.

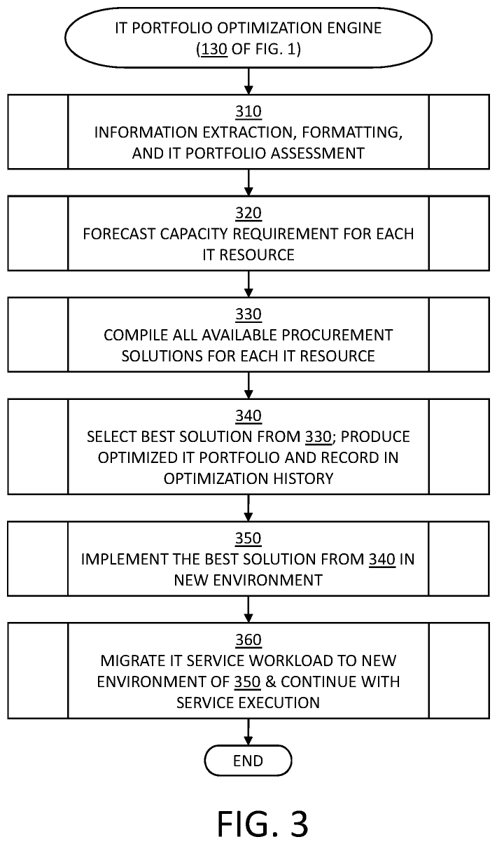

The IT portfolio optimization engine 130 produces an optimized IT portfolio 190 based on contents of the IT portfolio 110, the IT portfolio policy 131, the IT portfolio forecasting model 135, and the optimization history 137, and subsequently updates the IT portfolio 110 with the optimized IT portfolio 190. The IT portfolio optimization engine 130 updates the one or more IT resources 113, the one or more IT services 115, and/or the one or more IT projects 117, according to any contents corresponding to the IT resources 113, the IT services 115, and/or the IT projects 117, as specified in the optimized IT portfolio 190. Detailed operations of the IT portfolio optimization engine 130 are presented in FIG. 3 and corresponding description.

In one embodiment of the present invention, the IT portfolio policy 131 includes a standard convergence plan to automatically add on a new IT service system to the existing IT service systems 120 of the IT service provider 101. According to the standard convergence plan of the IT portfolio policy 131, the IT portfolio optimization engine 130 respectively evaluates IT resources, IT services, and IT projects of the new IT service system and integrates the respective elements of the new IT service system to the existing IT portfolio 110, based on preconfigured IT portfolio convergence parameters of the IT portfolio policy 131. The IT convergence parameters of the IT portfolio policy 131 include, but not limited to, respective resource requirements per IT service, respective identifications for currently used IT resource items per instance, type, category, remaining lifespan/lifecycle stage, respective suppliers and supplier specifications per item of the IT resources. Threshold values for respective lifecycles for the types of the IT resources 113 can be preconfigured in the IT portfolio policy 131, as a parameter of the IT resources 113 in the IT portfolio 110, or dynamically determined based on the technology trend of the type of the IT resource 113.

In one embodiment of the present invention, the IT portfolio optimization engine 130 checks certain parameters of new IT resources 113 from the optimized IT portfolio 190 against thresholds set in the IT portfolio policy 131 for automatically processing an order to purchase items of the IT resources 113 or executing steps of an IT project 117 when applicable. In the same embodiment of the present invention, the IT portfolio optimization engine 130 presents, to an administrator of the IT service system 120 or any other designated personnel, any IT projects 117 and/or IT resources 113 that are not authorized for automatic processing in the IT portfolio policy 131. The parameters set for the new IT resources 113 for automatic processing include, for example, a unit price of an item of the new IT resources 113, a quantity to purchase of the new IT resources 113, a total cost to purchase the new IT resources 113, a total savings resulting from the optimized IT portfolio 190 in comparison to a current cost for the same kind of IT resources 113, a remaining lifetime for each item of the new IT resource 113, and combinations thereof.

Embodiments of the present invention is to improve cost-effectiveness of the IT service system 120 with the optimized IT portfolio 110. The optimized IT portfolio 110 of the IT service system 120 automatically evaluates current states of the IT resources 113 and performs procurement processes of respective IT resources required for the IT services 115 at a minimal cost by use of the IT portfolio forecasting model 135. In certain embodiments of the present invention, the IT portfolio optimization engine 130 further updates the IT service system 120 into a new computing environment as set forth in the optimized IT portfolio 190. The IT service system 120 as updated with the optimized IT portfolio 190 continues with provisioning the IT services 115 according to existing terms of SLAs, by performing the workloads of the IT services 115 as agreed in the SLAs in the new environment for the IT service system 120 as implemented with the optimized IT portfolio 110. With the new computing environment for the IT service system 120 according to the optimized IT portfolio 190, the quality of service (QoS) of the IT services 115 will improve from the perspective of the IT clients as the IT service system 120 will run more efficiently and reliably with up-to-date IT resources 113.

In the same embodiments of the present invention as above where the IT service provider 101 operates more than one IT service system in distinctive locations, the IT service provider 101 can benefit from centralizing or otherwise systematically organizing operations of these multiple IT service systems to a coherent and unified IT service system 120. For example, the IT service provider 101 runs an IT service system A in Country A and another IT service system B in Country B. Both the IT service system A and the IT service system B provision similar IT services and, requires similar types of IT resources. In the same example, one of the IT resource is a software suite that can be purchased with an Enterprise License Agreement (ELA), which permits access to anyone that works for the IT service provider 101 across the world for a period of time. In the same example, the IT service system A and the IT service system B can gain accesses to the software suite without separately licensing the software suite, if the IT service provider 101 purchases the software suite under the ELA. However, if the IT service provider 101 is not aware of the common need for the software suite by the IT service system A and the IT service system B, because the IT portfolio 110 is not integrated across all IT service systems 120 of the IT service provider 101, Then, the IT service system A and the IT service system B would procure the software suite separately, which will incur more expense with the licensing than gaining access to the software suite under the ELA by the IT service provider 101.

Similarly, systematically cumulating IT resource requirement across all IT service systems of the IT service provider 101 and making the IT resource requirements of the IT service provide available in the IT portfolio 110 as a whole will enable more timely and less costly procurement of the IT resources based on economies of scale as with lower unit prices based on Volume Purchase Agreements (VPA) and less licensing fees based on ELAs for all member users of the IT service provider 101. Further, systematic and automated management of the IT resource requirements of the IT service provider 101 as a whole will enable keeping records of all resources of the IT service provider 101 coherently up-to-date across many locations respective to individual IT service systems. By use of the IT portfolio 110 as globally integrated, the IT service provider 101 can benefit from more powerful bargaining positions in procuring the IT resources 113, which can reduce the cost of the IT services 115 offered to the IT clients. Further, local regulations according to geographic locations of respective IT service systems can also be integrated into the IT portfolio 110 such that the IT services 115 can be implemented compliant to the local regulations based on a common framework of the IT service provider 101. For example, the IT service provider 101 will implement an IT service system within the European Union (EU) and the European Economic Area (EEA) according to the data protection and privacy requirements by the European Union General Data Protection Regulation (EU GDPR).

As noted conventional IT portfolio management is an organizational effort to apply a systematic management method to the investments, projects and activities of enterprise Information Technology (IT) departments, which is time consuming and error prone as being processed manually. An automatically evaluated and optimized IT portfolio management would be beneficial due to various reasons including, but not limited to, dynamic nature of changes in corporate environment, rapid evolution of the technologies involved in the IT efforts, shortened lifecycles for currently employed technologies, uncertainty with availability and support state of the currently employed technologies over a certain timeframe, distinctive local management styles of respective IT service system locations and dynamic changes in regulations applicable for the respective IT service system locations, dynamic changes in suppliers and respective purchase conditions for components of the IT technologies, dynamic changes in the changes in the IT resource requirements and the IT clientele, and changes with the enterprise IT departments with various locations.

For example, under the aforementioned dynamic circumstances with corporate environment, by use of the IT portfolio optimization engine 130, the IT service provider 101 can automatically add a new IT service system at a new location that had been previously operated by a business entity other than the IT service provider 101, and can optimize an integrated IT portfolio at the same time. The new IT service system would not be immediately compatible with the IT portfolio 110 of the IT service provider 101, as the new IT service system does not have any systematic management procedures for its IT portfolio, or the existing system management procedure for the IT portfolio of the new IT service system is not operable under the IT portfolio policy 131 for all IT service systems operated by the IT service provider 101. By use of the IT portfolio optimization engine 130, the IT service provider 101 can automatically integrate the IT portfolio of the new IT service system to the IT portfolio 110 of the IT service provider 101, by generating the optimized IT portfolio 190. As noted, the optimized IT portfolio 190 will be utilized in implementing more timely and less costly procurement of the IT resources for the IT service provider 101 as a whole, maintaining records of all resources of the IT service provider 101 coherently up-to-date across many locations with individual IT service systems. The optimized IT portfolio 190 will also implement regulatory standards that are applicable for the new IT service system according to the locality of the new IT service system, based on the regulatory standards set forth in the IT portfolio policy 131 per geographical location. As a result, the IT portfolio optimization engine 130 will not only optimize the existing IT portfolio 110 but also automates a large scale integration as in the case of the new IT service system into the existing IT portfolio 110, which will significantly save time and effort for the IT service provider 101 in integrating the new IT service system and keeping the IT portfolio 110 optimized over time and up-to-date with the technologies.

FIG. 2 depicts elements of the IT service system 120 of FIG. 1, in accordance with one or more embodiments set forth herein.

The IT portfolio 110 represents all resources and undertakings of the IT service provider 101 including the IT service system 120, as noted in FIG. 1. A set of resources particular to provisioning an IT service 205 is represented as IT resources 203 in the IT service system 120. The IT service 205 in the IT service system 120 is represented as the IT service 115 of the IT portfolio 110. The IT resources 203 in the IT service system 120 are represented as a set of the IT resource 113 in the IT portfolio 110. The IT portfolio optimization engine 130 can access all elements of the IT service system 120 as described in FIG. 3 and the corresponding description for the IT optimization engine 130.

The IT service 205 is provisioned for an IT client 201 according to a service level agreement (SLA) 225 between the IT client 201 and the IT service provider 101. The SLA 225 can cover more than one IT services including the IT service 205. In the SLA 225, various terms of agreed service levels for each IT service are defined. The IT service provider 101 will send service invoices to the IT client 201 for payment in exchange of the IT service 205 that is provisioned according to the terms of the SLA 225.

Typical terms of the SLA 225 for the IT service 205 can include service times, availability requirements, and performance requirements. The service times and the availability requirements of the IT service 205 are described in the SLA 225 with terms on including, but not limited to, agreed hours of the IT service 205, a number of interruptions allowed, availability thresholds in terms of percentage of hours while the IT service 205 is available over the agreed hours of the IT service 205, downtimes for maintenance including number of allowed downtimes, time period set aside for maintenance, pre-notification periods, and a procedure for announcing planned and/or unplanned interruptions to the IT service 205. The performance requirements of the IT service 205 are described in the SLA 225 with terms on including, but not limited to, required capacity described as a range with a lower limit and an upper limit for the IT service 205, allowed workload or usage of the IT service 205 that can be provisioned for the IT client 201, response times from applications servicing the IT service 205, reaction and resolution times on various incidents according to priorities, definition of priorities.

The IT resources 203 include resources of various types, including, but not limited to applications 211, software 213, hardware 215, communication networks 217, data 218, and environments 219, based on respective IT services 205. In this specification, the applications 211 indicate a set of one or more programs that performs tasks particular to the IT service 205, and the software 213 indicates all varieties of programs from operating systems, utilities, database management systems, to web browsers and word processors that support the IT service 205. The hardware 215 indicates parts and machines of computing equipment and peripheral devices that runs the software 213 and the applications 211 to provision the IT service 205. The data 218 indicate all types of digitized information for processing relevant to the IT service 205 and the IT portfolio 110. The environment 219 indicates an enterprise architecture of the IT service provider 101 in which workloads of the IT service 205 are performed, from an in-house data center to publicly accessible clouds. In this specification, the term “IT resource” is used as representative of any type of the IT resources 203, as described as the applications 211, the software 213, the hardware 215, the communication networks 217, the data 218, and the environments 219.

A certain element of the IT resources 203 is supplied by respective third party IT suppliers 231 according to an underpinning contract (UC) 235 between respective IT suppliers 231 and the IT service provider 101. Each of the IT suppliers 231 has a supplier specification 243 for a corresponding element of the IT resources 203. The supplier specification 243 describes one of the IT resources 203 in terms of functionality, capacity, available locations, and unit price, among many parameters. The IT suppliers 231 will send purchase/service invoices to the IT service provider 101 for payment in exchange of the goods and/or services supplied to the IT service provider 101 according to the terms of the UCs 235.

In the IT service system 120, the IT resources 203 and corresponding IT service 205 are managed with one or more IT projects 207 as implemented by one or more IT departments 209, referring to a group of people in the IT service provider 101 working on the IT projects 207. For example, installing a certain software suite to a particular server to perform a certain workload for a particular IT service is an instance of the IT projects 207. For another example, ensuring workload execution for the IT services 205 according to the terms of the SLA 225 is another instance of the IT projects 207. Certain IT projects 207 are governed by a corresponding operational level agreement (OLA) that defines respective responsibilities as to the resources to prepare and roles to perform in order to support delivery of the IT services 205 to the IT clients 201 amongst various departments within the IT service provider 101.

According to the SLA 225, the IT service system 120 often keeps an IT service quality plan to ensure that the IT service 205 is provisioned according to the SLA 225. According to the IT service quality plan, the IT service provider 101 measures certain performance indicators such as processing speed, throughput, network bandwidth, a number of accesses to the IT service 205 at one time, or the like, according to respective measurement procedures. The IT service provider 101 also checks interrelationship between the IT service 205 and other IT services that may be relevant to the SLA 225. The IT service provider 101 also need to assign the IT service 205 to the one or more IT departments 209 and to define the IT project 207 to support the IT service 205. Further the IT service provider 101 identifies and procures external services and resources with a certain IT supplier 231 by use of respective underpinning contracts 235.

FIG. 3 depicts detailed operations of the IT portfolio optimization engine 130 of FIG. 1, in accordance with one or more embodiments set forth herein.

Blocks 310 through 380 as presented below describe respective processes that are performed by the IT portfolio optimization engine 130. Each block indicates respective predefined processes that include multiple subprocesses of distinctive sequences that takes identical inputs and generates identical outputs. Where no logical order is inherent, the subprocesses of the blocks can be performed concurrently, in accordance with embodiments of the present invention.

As noted, the IT portfolio optimization engine 130 can access all elements of the IT service system 120, as presented in FIG. 2, as well as the IT portfolio 110, to take as inputs in evaluating current states of the IT portfolio 110 as implemented in the IT service system 120, in modeling the IT portfolio forecasting model 135, in generating the optimized IT portfolio 190, and to update the IT service system 120 with the optimized IT portfolio 190.

Conventionally IT portfolios is governed by long-term, large-scale strategies and organizational objectives, as well as short-term, limited-scope opportunities that fit the strategies and objectives of the organization. Assessing all operations, including the IT services 115 and the IT projects 117, that consumes the IT resources 113 across all IT service systems 120 of the IT service provider 101 according to these strategies and objectives is an activity of IT portfolio management.

The IT portfolio optimization engine 130 automates certain activities of the traditional IT portfolio management operations by automatically assessing the IT resources 113 respective to requirements of the IT services 115 and the IT projects 117, and further performs optimization of the IT portfolio 110 by automatically identifying the elements of the IT portfolio 110 for replacements, and seamlessly implements the optimized IT portfolio 190 on the IT service system 120 by integrating the identified elements of the optimized IT portfolio 190 in the IT service systems 120, as described below.

In certain embodiments of the present invention, the strategies and objectives of the IT service provider 101 for the purpose of the IT portfolio management include, but not limited to, improving cost effectiveness of the IT service systems 120 while provisioning the IT services 113 that satisfy terms of respective SLAs 225. The strategies and objectives of the IT service provider 101 can be categorized and prioritized and can have a certain amount of budget set aside for each category according to the IT portfolio policy 131. For example, the IT service provider 101 can set a priority for quality assurance of existing IT services higher than an application development project of a new IT service, and vice versa, according to organizational perspectives of the IT service provider 101.

The IT portfolio policy 131 of the IT portfolio optimization engine 130 configures various threshold parameter values for automated decisions that can be made by the IT portfolio optimization engine 130, to ensure that the optimized IT portfolio 190 can be automatically implemented with the IT service systems 120 without any adverse effects to the IT service provider 101. For example, the IT portfolio policy 131 can set a certain percentage from the IT budget, or a particular amount, as a threshold for automated decision and implementation with the IT service systems 120, for a single instance of the optimized IT portfolio 190 or a cumulative effect of multiple optimized IT portfolio 190 over a certain period of time, namely, a quarter or a fiscal year.

In block 310, the IT portfolio optimization engine 130 extracts information relevant to IT services provisions and IT resources requisition from all available elements of the IT service system 120 and records the extracted information in a predefined unified format as a current state of the IT portfolio 110. The IT portfolio optimization engine 130 assesses performance of the current IT portfolio 110 based on the information extracted from the IT service systems 120 as well as prospected future needs on the IT resource capacity requirements over a certain period of time in the future. Then, the IT portfolio optimization engine 130 proceeds with block 320.

In one embodiment of the present invention, the IT portfolio optimization engine 130 collects IT service invoices corresponding to the SLAs 225 and IT resource goods/services invoices corresponding to the UCs 235 of the IT service 205 that had been previously provisioned and/or currently due for payment, from the IT service systems 120. The collected invoices and contracts are relevant to respective items of the IT resources 113, the IT services 115, and the IT projects 117 of the IT portfolio 110 in a current state.

In the same embodiment of the present invention as above, the IT portfolio optimization engine 130 extracts values corresponding to preconfigured parameters to assess the IT portfolio 110 in the current state by processing the collected invoices and contracts with the NLP/NLC tools 140 based on the IT portfolio ontology 150. The IT portfolio ontology 150 defines the nomenclature and hierarchical structure of the variables appearing in the IT portfolio 110. Based on the IT portfolio ontology 150, the IT portfolio optimization engine 130 defines the unified format to represent the IT resources 113 of the IT portfolio 110 respective to the IT services 115 and the IT projects 117. Details of the IT resource 113 is presented in FIG. 2 by use of the IT resources 203 respective to the IT service 205, and each type of the IT resources 203 can be described by the unified format in the IT portfolio 110. For example, the unified format for elements of the IT portfolio 110 can have a variable to represent each element in the IT portfolio 110, and the variable has a set of attributes to identify the element represented by the variable and to describe features of the element, including, but not limited to, categories/types of the element including any classification and subclassification, functionality of the element, a stage in a lifecycle of the element and technology trend of the element, price ranges and budget to procure the element, known suppliers of the element, locational availability/preference on each known supplier of the element, and dependencies with other elements, discount status and procurement requirement qualified for a certain discount based on VPAs and/or ELAs, a possible substitute element, etc.

The NLP/NLC tools 140 parses, or tokenizes, the collected invoices and contracts from the IT service systems 120 down to the elements of numbers, words, and phrases matching the nomenclature defined in the IT portfolio ontology 150. The IT portfolio optimization engine 130 extracts information on the IT portfolio 110 by compiling data values corresponding to the words/phrases appearing in the nomenclature of the IT portfolio ontology 150. A few examples of the variables appearing in the IT portfolio 110 include, but not limited to, service name, service capacity requirements, permitted downtime, service price, item name, item capacity, item functionality, item price, growth rate of demand on item and timeframe prospect, growth rate of demand on service and timeframe prospect, supplier specifications including available locations and discount qualifications.

For example, the IT portfolio ontology 150 sets forth variables “storage”, “server”, “software”, “network”, “labor” , and variables “data center”, “private cloud”, and “public cloud” in the category “IT resource”. The variables “storage” and “server” can be of the subcategory “hardware”, the variable “software” can be also a subcategory “software” that includes a variable “application”, and the variable “network” can be of a subcategory “service support”. The variable “labor” can be of a subcategory “human resource”, and the variables “data center”, “private cloud”, and “public cloud” can be of a subcategory “environment” indicating a platform of each IT service. When the IT portfolio optimization engine 130 processes the collected invoices and agreements by use of the NLP/NLC 140, the terms used for variable names in the IT portfolio ontology 150 are extracted from the invoices and agreements and classified according to a hierarchy set forth in the IT portfolio ontology 150. The IT portfolio ontology 150 further defines attributes corresponding to respective variables appearing in the IT portfolio 110, including, but not limited to, a range of acceptable values for a numeric variable, a type of the variable, a set of available values for the variable, subcategories and categories of the variables, applicable prices and locations for the item indicated by the variable, and a stage in lifecycle of the item indicated by the variable. For example, a certain items of the IT resources in the current IT portfolio 110 can be out of support hardware and/or software due to a newly adopted standard on more advanced version of the same technology.

In certain embodiments of the present invention, the invoices and contracts of the IT service systems 120 can be in many kind of languages. The IT portfolio optimization engine 130 can first convert the invoices and contracts from various languages to a standard language that is most beneficial to the IT service provider 101 by use of the NLP/NLC tools 140, prior to extracting lexical elements and data from the invoices and contracts.

In order to ensure accuracy in translation of the invoices and contracts from local languages to the standard language, the IT portfolio ontology 150 can have additional information. Because certain words from various local language can be translated out of context of the IT portfolio optimization in case of general translation with generic NLP tools, the IT portfolio optimization engine 130 can reinforce the IT portfolio ontology 150 with frequent words in various local languages to respective terms in the standard language as used in the context of IT portfolio management and optimization. As a result, the NLP/NLC tools 140 can easily identify and translate industry relevant terms appearing in the invoices and contracts in local languages to more accurate respective terms of the standard language.

The IT portfolio optimization engine 130 subsequently assesses actual results achieved by the current IT portfolio 110 of the IT service provider 101 by analyzing the extracted information. The IT portfolio optimization engine 130 assesses the current IT portfolio 110 in terms of value realized in provisioning the IT services 115 and the standing of the IT service provider 101 in terms of performance and/or market share, profit analyses and respective balances of respective IT service systems 120 and a cumulated balance of the IT service provider 101 in terms of expenses and revenue, and any other performance measure as defined by the IT service provider 101. The IT portfolio optimization engine 130 further evaluates how well the IT portfolio 110 in the current state is aligned with strategic long-term goals of the IT service provider 101, which can be preconfigured into the IT portfolio policy 131 as certain variables and respectively corresponding ranges of values.

In certain embodiments of the present invention, the IT portfolio optimization engine 130 builds a machine learning model of inputs including the invoices and contracts with respect to typical variables and corresponding ranges of values, formats, and required attributes and corresponding ranges of values for respective variables appearing in particular types of inputs, by use of the CA/ML tools 160 with a current instance of the IT portfolio 110 as a training data. As a result, the IT portfolio optimization engine 130 can extract information from the invoices and contracts by checking the extracted information against the machine learning model of inputs and filtering out non-standard variables and/or abnormal values that are significantly distant from the range of values acceptable for the variables in the machine learning model of inputs.

Further, the IT portfolio optimization engine 130 trains the input model to unify representation of a same item of resource regardless of senders or recipients in order to aggregate the purchases in order to identify any opportunities for a lower price based on the purchase volume of the items, if the same item of resource is discretely supplied to many IT departments across the IT service systems 120 of the IT service provider 101, suppliers or to which IT department identify invoices from a same supplier. The IT portfolio engine 130 also trains the input model to identify a same supplier in multiple purchases in order to identify any opportunities to aggregate the purchases and to procure the same items of resources at a lower price, as in cases of VPAs and/or ELAs.

The IT portfolio optimization engine 130 records the extracted information in the IT portfolio 110 as a current state. Prior to recording the current IT portfolio 110, the IT portfolio optimization engine 130 processes the extracted information for interrelationships between service functionality and resource capacity, technological trend with respective resources as in average lifecycles and adoption curves and corresponding timeframe, respective growth rate in demand and/or deterioration in capacity and availability technical support for respective resources, as well as interdependencies amongst services and resources in the variables of the current state IT portfolio 110, depending on particular set of values in attributes of the variables. For example, when the IT service of the current IT portfolio 110 is a remote data service as in live/video streaming, the IT service depends on Internet connectivity of the IT client of the IT service, which may or may not be provisioned by the IT service provider 101. For another example, the IT portfolio optimization engine 130 will identify a dependency in supplier, location, and price for an item of a resource, if a certain supplier provides the resources in a particular location at a certain price but no other suppliers in other locations offers the same price for the same item. For still another example, the IT portfolio optimization engine 130 will identify a dependency in a geographical location and storage encryption requirements for certain IT services, if a certain country has a regulation mandating all IT service providers to store personal data of clients within a geographic jurisdiction in a secure encrypted storage location.

In block 320, the IT portfolio optimization engine 130 forecasts capacity requirements of respective IT resources that are required for each IT service, by use of the IT portfolio forecasting model 135. Prior to forecasting, the IT portfolio optimization engine 130 establishes the IT portfolio forecasting model 135 by use of cognitive analytics/machine learning tools 160 based on the current IT portfolio 110 in the unified format for all types of IT resource that represents information extracted from block 310 as training data. Then, the IT portfolio optimization engine 130 proceeds with block 330.

The IT portfolio optimization engine 130 builds respective IT resource forecasting models that are elements of the IT portfolio forecasting model 135. In certain embodiments of the present invention, the IT portfolio optimization engine 130 builds each IT resource forecasting model for each IT service based on demands by respective IT services of a particular IT resource, and aggregate all capacity requirements for the IT resource when more than one IT service is considered. In other embodiments of the present invention, the IT portfolio optimization engine 130 builds a shared IT resources forecasting model based on characteristics of the IT resources and typical past deployments by the IT service provider 101, that is commonly applicable to all IT services of the IT service provider 101.

In one embodiment of the present invention, in order to forecast demands on a particular IT resource at a certain time in the future, the IT portfolio optimization engine 130 obtains inputs of: current resource demands of all resources required to provision the IT service, respective demand growth rates per year for each resource, a timeframe for resource demand forecasting into a certain number of period units, and a contingency amount that might be required in addition to the forecasted demand on respective resources.

For example, the IT portfolio optimization engine 130 determines the system requirements for a server in three (3) years for IT service S, which is one of the IT services 205, provisioned by the IT service provider 101. The IT portfolio optimization engine 130 builds a server forecasting model, among other IT resources of the IT service S, to execute projected workloads of the IT service S in k number of years, where k is greater than or equal to three (3) and less than or equal to ten (10), that is, 3≤k≤10, which is a timeframe for forecasting the server capacity. The IT portfolio optimization engine 130 can build distinctive resource demand forecasting model for a difference scale of the timeframe, with varying factors in making the considerations such as technology trend.

In the same example as above, the IT resource of server is represented in the IT portfolio 110, by variable “server” with attributes including but not limited to “CPU”, “memory”, “disk”, and “network”, which are typically descriptive of server specifications, under category “server capacity”. Respective attributes of variable “server” has values in respective units applicable for each type of the resources in a server, as in value of “40×4×5.2” for the attribute “CPU”, indicating that the CPU has forty (40) quad-core processors of clock speed 5.2 GHz, and/or as in value of “52000 MIPS”, indicating that the CPU can process 52,000 Million Instructions Per Second (MIPS). The “server” variable can further have “CPU utilization” attribute with a value “0.65”, indicating that the server with a CPU capacity can perform at sixty five percent (65%) of the CPU capacity in executing workloads for the IT service S.

In the same example as above, the IT portfolio optimization engine 130 obtains projected growth rates for respective resources for a server as an input from a human user who administers operations of the IT portfolio optimization engine 130. Or, the IT portfolio optimization engine 130 can calculate a growth rate for the respective resources based on past instances of the IT portfolio 110, based on runtime configuration of the IT portfolio optimization engine 130. In certain embodiments of the present invention, the IT portfolio optimization engine 130 calculates the growth rate for a certain resource based on past instances of the IT portfolio 110 relevant to growth pattern in demands for the same resource, and use the numbers as training data for the IT resource forecasting model.

In the same example as above, the IT portfolio optimization engine 130 obtains or calculates the contingency amount of the server, as in a certain percentage of the forecasted demand for the server resource to have in addition to the forecasted demand in preparation of unexpected events that may drive up the demand for the server resource during the timeframe of three (3) years. In certain embodiments of the present invention, the IT portfolio optimization engine 130 calculates the contingency amount ratio for a certain resource based on past instances of the IT portfolio 110 relevant to the contingency demand for the same resource, and use the numbers as training data for the IT resource forecasting model.

In the same example as above, the IT portfolio optimization engine 130 produces the forecasted server demand changes in three (3) years from now, provided that the yearly growth rate for the server demand is seven percent (7%), by multiplying the current server capacity demand, the yearly growth rate for the server demand, and the number of years in the forecasting timeframe, and by adding the contingency amount for the server. The IT portfolio optimization engine 130 adds the forecasted server demand changes to the current capacity of the server resource to produce a total demand on server resource in three (3) years. If the IT service S had a growth rate less than zero (0), indicating that the IT service S is declining, the total demand on server resource in 3 years will be less than the current capacity of the server resource. The IT service provider 101 can use the total demand on server resource in three (3) years, in order to have the server capacity corresponding to the forecasted total demand on the server resource, in preparation of the forecasted growth in demand for the server resource, as described below.

The IT portfolio optimization engine 130 performs block 320 for each resource and/or for each IT service/project, and cumulates the respective demand forecasting models for resources into the IT portfolio forecasting model 135 for all IT resources of the IT portfolio 110.

In block 330, the IT portfolio optimization engine 130 compiles all available terms and conditions for procurement solutions to have IT resources supplied to satisfy the capacity requirements as forecasted in block 320. Then, the IT portfolio optimization engine 130 proceeds with block 340.

In one embodiment of the present invention, the IT portfolio optimization engine 130 first determines one or more optimal items of the IT resource that matches the capacity requirement forecasted for the IT resource in block 320, within a certain preconfigured range. The items of the IT resource can be implemented in various forms, depending on the respective IT suppliers 231. For example, when the IT resource is computing capacity of any kind, the optimal items can be a particular piece of machinery or a computing service that offers the computing capacity as forecasted. The respective matching categories and threshold ranges, for example, five percent (5%), seven percent (7%), or any other margin for contingency demands, of capacities for specific item of the IT resources can be preconfigured in the IT portfolio policy 131 of the IT portfolio optimization engine 130.

In the same embodiment of the present invention, the IT portfolio optimization engine 130 then determines all available procurement options for the optimal items of the current IT resource based on certain conditions. Examples of the conditions for determining available procurement options include, but are not limited to, local regulation, client demands, and terms of the IT portfolio policy 131 by the IT service provider 101. For example, where no restriction on physical isolation of the infrastructure, the IT portfolio optimization engine 130 examines both private solutions and public solutions. For another example, where the infrastructure of the IT service system 120 is required to be private according to one or more of the aforementioned conditions, the IT portfolio optimization engine 130 examines only private solutions. Examples of the private solutions for the IT resource of “server”, as represented in the same variable of the IT portfolio 110, include, but are not limited to, one or more private servers operated by the IT departments 209 of the IT service provider, 101, and one or more servers reserved for the IT service provider 101 from a data center operated by a third party supplier that is one of the IT supplier 231. Examples of the public solutions for the same IT resource of “server”, include, but are not limited to, computing services available from public clouds.

In the same embodiment of the present invention as above, the IT portfolio optimization engine 130 subsequently compiles respective prices for all available procurement options particular to the best option of the IT resource 203 for the IT service 205 that is being optimized. As the IT portfolio optimization engine 130 optimizes for a particular one of the IT services 205, the IT portfolio optimization engine 130 compares the prices for all available procurement options for each of the IT resources 203 that are required to provision the particular IT service 205.

When the IT service provider 101 optimizes the IT portfolio 110 for multiple IT services 205 across all IT service systems 120, the IT portfolio optimization engine 130 would require numerous iteration for preparing available procurement solutions for the best items respective to forecasted capacity requirements for the same IT resource 203. The IT portfolio optimization engine 130 records all compilations of the available procurement solutions corresponding to each IT resource 203 in the optimization history 137, which can be used as training data for the forecasting model for the IT resource in a next run for optimizing the same IT resource as performed by the IT portfolio optimization engine 130.

In the same embodiment of the present invention as above, the IT portfolio optimization engine 130 generates a list of available procurement solutions by compiling the list of suppliers and respective supplier specifications describing terms offered for the selected best items of the IT resource as to functionality, capacity, available locations, unit price, and other conditions such as discount qualifications for volume purchases, bundles, and promotional rebates. In the same embodiment, the IT portfolio optimization engine 130 can further compute a new way of procuring the IT resource based on the current unit price and the discount qualifications that can be attained by the IT service provider 101, as preconfigured by the IT portfolio policy 131 and other information on the IT service provider 101 and the IT service systems 120. For example, if the needs for the item under review across all IT service systems 120 of the IT service provider 101 exceeds the volume that qualified under the VPAs or ELAs price for respective suppliers. Then, the IT portfolio optimization engine 130 fills in the attainable discount options in the compilation of available procurement solutions for the optimal item of the IT resources 203.

In certain embodiments of the present invention, the IT portfolio optimization engine 130 is configured to examine further solutions more complex than procurement including, but not limited to, a consolidation/distribution of data centers, a migration from a server to a cloud, development of proprietary application to a commercial available software suite of similar functionality. The IT portfolio optimization engine 130 can provide framework for such options with basic analysis on availabilities and prices based on technology and industry trends for the IT service provider 101.

In block 340, the IT portfolio optimization engine 130 selects a best solution for procuring the respective IT resources from the list of available procurement solutions produced in block 330. The IT portfolio optimization engine 130 produces the optimized IT portfolio 190 subsequent to aggregating the best solutions for all IT resources 203 that are being optimized. The IT portfolio optimization engine 130 updates the IT portfolio 110 and records the optimized IT portfolio 190 in the optimization history 137. Then, the IT portfolio optimization engine 130 proceeds with block 350.

In one embodiment of the present invention, the IT portfolio optimization engine 130 applies selection criteria/priorities, price thresholds for automated selection, and other automation control parameters preconfigured in the IT portfolio policy 131 in selecting the best solution from the list of available procurement solutions. As noted, the IT portfolio policy 131 sets forth strategic preferences in optimizing the IT portfolio 110 automatically but within the boundaries set in the IT portfolio policy 131. For example, the IT portfolio policy 131 can set the selection criteria/priorities as the lowest price amongst all items of the IT resource of similar capacities and functionalities, but only when the lowest price is within a certain percentage of an IT budget for the IT service for which the IT resource is required. If there are any selected best solutions for the IT resources that do not meet all conditions in the IT portfolio policy 110 for automated IT portfolio optimization and subsequent automated implementation, then the IT portfolio optimization engine 130 will not produce the optimized IT portfolio 190 and terminate, or will report the optimized IT portfolio 190 with details on occurrences of policy violations without automatically recording the result in the optimization history 137.

In the same embodiment of the present invention as above, the IT portfolio optimization engine 130 records the optimized IT portfolio 190 in the optimization history 137. The optimized IT portfolio 190 includes, for each IT resource, a best solution for the IT resource amongst their respectively available procurement solutions on the best item of the IT resource that satisfies the forecasted capacity requirements the closest amongst all other items. The best solution for the IT resource also meets the conditions for automated IT portfolio optimization and implementation as set forth in the IT portfolio policy 131. The IT portfolio optimization engine 130 records the optimized IT portfolio 190 in the optimization history 137 repository, which will be used to train the IT portfolio forecasting model 135. The IT portfolio optimization engine 130 trains and updates the IT portfolio forecasting model 135 as the optimized IT portfolio 190 accumulates in the optimization history 137 repository, by use of the CA/ML tools 160.

In block 350, the IT portfolio optimization engine 130 implements the best solutions for procuring the respective IT resources as selected from block 340. As a result, the IT portfolio optimization engine 130 will establish a new environment for the IT services 205 represented by the optimized IT portfolio 190, which include the best procurement solutions for each IT resource. Then, the IT portfolio optimization engine 130 proceeds with block 360.

In certain embodiments of the present invention, the IT portfolio optimization engine 130 additionally implements any support elements for the IT resource in the best solution. The IT portfolio optimization engine 130 identifies the support elements for the IT resources based on IT resource dependencies and/or IT service dependencies for which the IT resources are required. For the same example aforementioned as the streaming service depending on the Internet connectivity, the IT portfolio optimization engine 130 can identify new network equipment with higher speed and broader bandwidth with more access points for the supporting Internet connectivity, when the streaming service is optimized and upgraded with a higher grade computing machinery/facility that can service thirty percent (30%) more end users at one time than before, in order to fully utilize the increased computing capacity.

In certain embodiments of the present invention, the IT portfolio optimization engine 130 implements the best procurement solution as selected from block 340 by automatically placing purchase orders according to the description of the best procurement solution. In the same embodiment, the IT portfolio optimization engine 130 has supporting infrastructure that enables automated ordering and automated administration of IT budgets for corresponding payment, as prescribed by the IT portfolio policy 131. The implementation of the best procurement solution can involve physical relocation of products and equipment, which can also be automatically managed by the IT portfolio optimization engine 130 by use of the automation supporting infrastructure for issuing requests for service corresponding to the needs to the IT departments 209 and third party participants including the IT suppliers 231. The purchase order and work orders that had been automatically issued by the IT portfolio optimization engine 130 can be subject to monitoring and supervision by human administrator or by a particular IT department if necessary.

In block 360, the IT portfolio optimization engine 130 migrates workload for IT services to provision to a new environment of the IT service system 120 resulting from block 350. The IT portfolio optimization engine 130 subsequently continues with facilitating the IT service 205 to execute the service workload in the new environment. Then, the IT portfolio optimization engine 130 terminates one exercise of the IT portfolio optimization.

In one embodiment of the present invention, the IT portfolio optimization engine 130 obtains inputs of identifiers of IT service workloads that are subject to migration, and instructions and conditions on how to migrate the respective IT service workloads. Depending on the characteristics of the IT service, certain IT service workloads cannot be migrated without discontinuing the IT service for a certain period of time, and accordingly, the IT portfolio optimization engine 130 can analyze and train the types of IT service workload and migration instructions in the optimization history 137 for future references. If the period of discontinued service is longer than a permitted downtime in the SLA for the IT service, the IT portfolio optimization engine 130 will report human administrator/the IT department as such and terminate.

In this specification, the IT service workload indicates the amount of processing to be done by a certain computing hardware at a given time to provision the IT service. In the same example as the variable “server” is represented in the IT portfolio 110, a throughput of the server is in a unit of “Million Instructions Per Second (MIPS)” as represented in the attribute “CPU”. Typical IT service workload can include a certain number of application programs running on the front, user interface support for remote users interacting with the front application programs, as well as some background jobs for processing for infrastructure and data preparation. IT service workloads are typically allocated for a certain reserved computing resources such that the IT service can be continuously provisioned to the IT clients and users according to the terms of the SLA corresponding to the IT service.

Where the IT portfolio optimization engine 130 can automatically migrate the IT service workloads to the new environment corresponding to the optimized IT portfolio 190, the IT portfolio optimization engine 130 continues with facilitating the IT service 205 to execute the IT service workload as migrated in the new environment. For example, the IT portfolio optimization engine 130 update workload allocation configuration parameter with the IT service with a path information to the new environment, or provide a credential or otherwise facilitate authentication for the IT service to access the new information, as well as redirect any incoming IT service workload to the new environment.

Subsequent to completing an optimization exercise, the IT portfolio optimization engine 130 can monitor performance of the optimized IT services and evaluate how well or poorly the IT portfolio optimization engine 130 perform with the previous exercises. The IT portfolio optimization engine 130 can apply a certain performance threshold value, configured in the IT portfolio policy 131, to determine whether or not a certain optimization exercise can be used in the training data for the IT portfolio forecasting model 135.

In certain embodiments of the present invention where the IT resource needs periodic updates due to lifecycle changes, the IT portfolio optimization engine 130 can automatically run in an interval for optimizing the IT resource at issue. Also the IT portfolio optimization engine 130 can have triggering events for rerun the optimization cycle according to the industry/technology trend and typical lifespans respective to each type of the IT resources. The IT portfolio optimization engine 130 can also be scheduled for recurring optimization on IT resources of a particular IT service, based on a service quality plan for the particular IT service, where the service quality plan is stipulated in the SLA for the particular IT service.

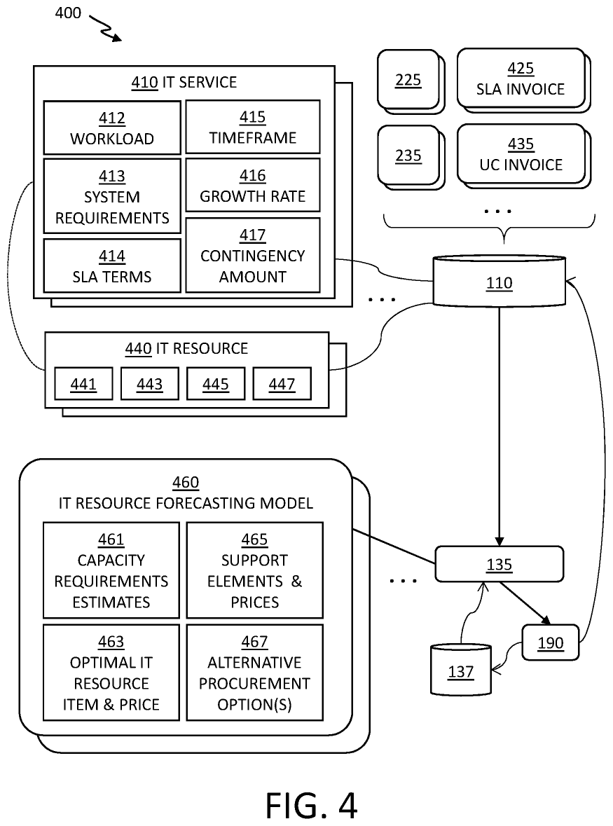

FIG. 4 depicts an exemplary data flow 400 for the IT portfolio forecasting model 135, in accordance with one or more embodiments set forth herein.

In the exemplary data flow 400 of FIG. 4 for the IT portfolio forecasting model 135, the IT portfolio optimization engine 130 performs operations described in FIG. 3 and corresponding description.

According to operations in block 310 of FIG. 3, the IT portfolio optimization engine 130 collects inputs of the SLAs 225 and the UCs 235 in the IT service system 120. The IT portfolio optimization engine 130 also collects SLA invoices 425 and UC invoices 435, which are respectively corresponding to each of the SLAs 225 and the UCs 235 of the IT service system 120. The IT portfolio optimization engine 130 extracts information from the collected inputs and records as respective IT elements in a unified format predefined for the IT portfolio 110, with variables and corresponding attributes and values, according to categories, types, attributes, and hierarchies defined in the IT portfolio ontology 150.

In one embodiment of the present invention, an IT service variable 410 in the IT portfolio 110 represents one of the IT services 205 of the IT service system 120, according to the information extracted from the contracts and invoices, as resulting from the operations in block 310 of FIG. 3. In the same embodiment, the IT service variable 410 has attributes including, but not limited to, a workload 412, system requirements 413, SLA terms 414, a timeframe 415, a growth rate 416, and a contingency amount 417, which had been respectively noted as in the descriptions of FIG. 3.

In the same embodiment as above, an IT resource variable 440 in the IT portfolio 110 represents one of the IT resources 203 associated with the IT service variable 410 in the IT portfolio 110, as resulting from the operations in block 310 of FIG. 3. The IT resources 203 of the IT service system 120 represents some of the IT resources 113 that can be procured from respective suppliers. The IT resource variable 440 has attributes including, but not limited to, an identifier 441, a procurement conditions 443, a resource utilization 445, and a lifecycle stage 447.

The identifier 441 of the IT resource variable 440 identifies which IT resource is described by the IT resource variable. The identifier attribute 441 of the IT resource variable 440 can have associated sub-attributes including, but not limited to, a resource name, a resource type/class, a particular item number, and corresponding values for respective ID relevant attributes. The procurement conditions attribute 443 of the IT resource variable 440 can have associated sub-attributes including, but not limited to, a list of suppliers, available locations, and prices per location for each supplier. The resource utilization attribute 445 of the IT resource variable 440 can have associated sub-attributes including, but not limited to, measurement units, average utilization of the class, substitute candidate resource, etc. The lifecycle stage attribute 447 of the IT resource variable 440 can have associated sub-attributes including, but not limited to, a total number of stages used, a current lifecycle stage, a remaining lifespan, a support expiration date, etc.

According to operations in block 320 of FIG. 3, the IT portfolio optimization engine 130 generates an IT resource forecasting model 460 for respective IT resources of the IT service 205 based on the contents of the IT portfolio 110. As noted, the IT portfolio forecasting model 135 is a collection of the IT resource forecasting models for all IT resources required for all IT services subject to optimization. The IT resource forecasting model 460 includes elements of capacity requirement estimates 461, optimal IT resource item and price 463, support elements and prices 465, and alternative procurement options 467 according to conditions on discount qualification by suppliers of the IT resource as well as procurement options for any other resources that can substitute the IT resource.

According to operations in block 330 of FIG. 3, the IT portfolio optimization engine 130 compiles available procurement solutions for the optimal IT resource item 463 that best fits the capacity requirements estimates 461, based on the supplier specifications for the optimal IT resource item 463. According to operations in block 340 of FIG. 3, the IT portfolio optimization engine 130 produces the optimized IT portfolio 190 by selecting the best procurement solution from the result of block 330. The IT portfolio optimization engine 130 records the optimized IT portfolio 190 in the optimization history 137 as well as updates the IT portfolio 110. The optimization history 137 is used as a training data for the IT portfolio forecasting model 135 subsequent to evaluating the performance of the IT service system 120 according to the optimized IT portfolio 190.

Certain embodiments of the present invention automatically optimize an IT portfolio by automatically extracting information of IT service systems of an IT service provider, by unifying representation format for elements of the IT service systems in the IT portfolio, by forecasting respective capacity demands for each of the IT resources, and by automatically selecting best available procurement options corresponding to the capacity demands as forecasted. Certain embodiments of the present invention streamline information extraction from the IT service systems by unifying languages of the contracts and invoices of the IT service system by use of natural language processing/natural language classification tools. Certain embodiments of the present invention further standardize information extraction from the IT service systems by use of IT portfolio ontology in classification and formulating data in the IT portfolio. Certain embodiments of the present invention automates estimation of future capacity demands for the IT resources of the IT service system with IT resource capacity forecasting models respective to each type of IT resources by use of machine learning tools. Certain embodiments of the present invention can be implemented by use of a cloud platform/data center in various types including a Software-as-a-Service (SaaS), Platform-as-a-Service (PaaS), Database-as-a-Service (DBaaS), and combinations thereof based on types of subscription on a service for entities that can benefit from the IT portfolio optimization service with their IT infrastructure. The IT portfolio optimization service can be provided for subscribed entities of any type with aforementioned IT needs from any location in the world.

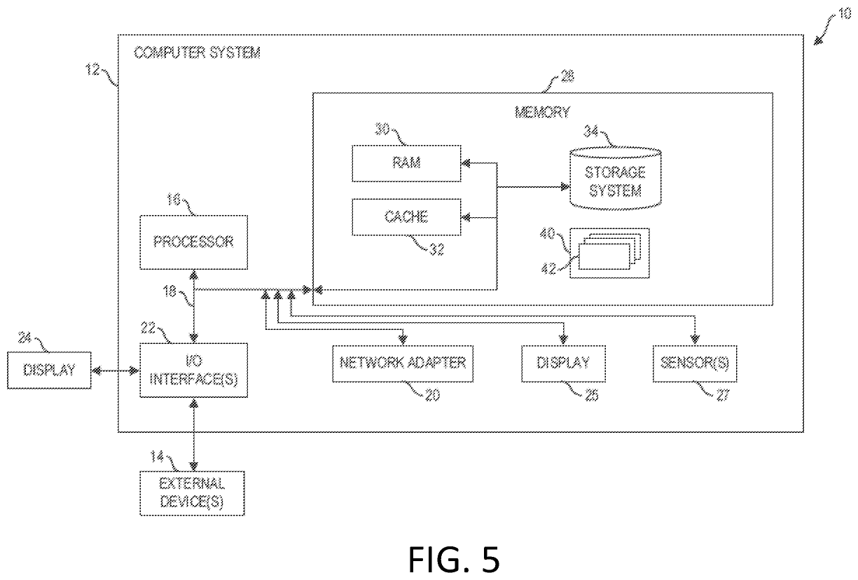

FIGS. 5-7 depict various aspects of computing, including a cloud computing system, in accordance with one or more aspects set forth herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 5, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile memory device (e.g., a “thumb drive”, “external hard drive”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the IT portfolio optimization engine 130 of FIG. 1. Program processes 42, as in the IT portfolio optimization engine 130 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18.

In addition to or in place of having external devices 14 and the display 24, which can be configured to provide user interface functionality, computing node 10 in one embodiment can include another display 25 connected to bus 18. In one embodiment, the display 25 can be configured as a touch screen render and can be configured to provide user interface functionality, e.g. can facilitate virtual keyboard functionality and input of total data. Computer system 12 in one embodiment can also include one or more sensor device 27 connected to bus 18. One or more sensor device 27 can alternatively or in addition be connected through I/O interface(s) 22. The one or more sensor device 27 can include a Global Positioning Sensor (GPS) device in one embodiment and can be configured to provide a location of computing node 10. In one embodiment, the one or more sensor device 27 can alternatively or in addition include, e.g., one or more of a camera, a gyroscope, a temperature sensor, a humidity sensor, a pulse sensor, a blood pressure (BP) sensor or an audio input device.

It should be understood that although not shown, other hardware and/or software components could be used in conjunction with computer system 12. Examples, include, but are not limited to: microcode, device drivers, redundant processors, external disk drive arrays, RAID systems, tape drives, and data archival storage systems, etc.

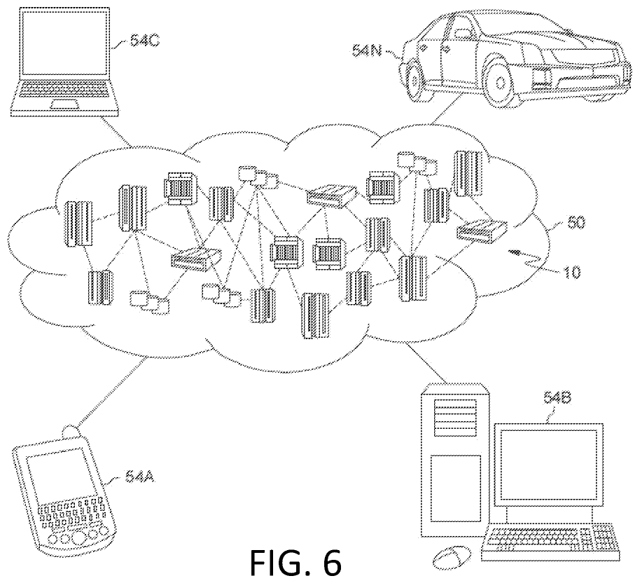

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

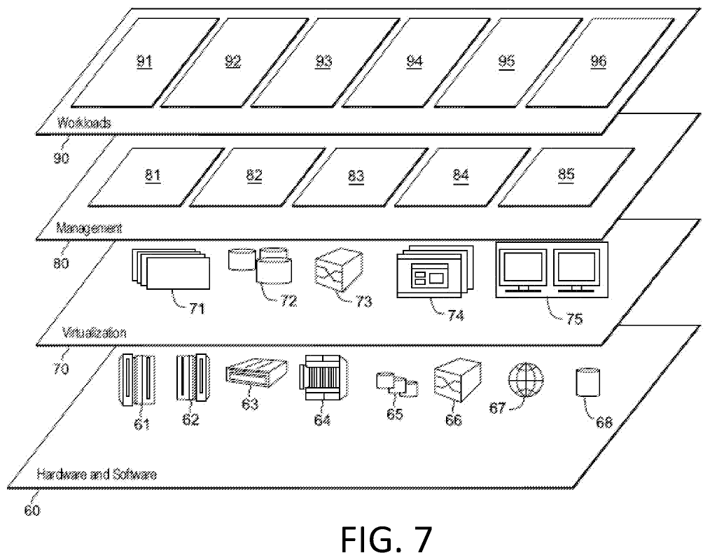

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the IT portfolio optimization engine 96, as described herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method, comprising:
collecting, by one or more processor, inputs from one or more information technology (IT) service systems, wherein the inputs comprise one or more service level agreements (SLAs), one or more SLA invoices corresponding to the one or more SLAs, one or more underpinning contracts (UCs), and one or more UC invoices;
extracting, by the one or more processor, information on one or more IT services and one or more IT resources corresponding to an IT service of the one or more IT services from the inputs, wherein an IT service system of the one or more IT service systems provisions the IT service to an IT client by using the one or more IT resources;
forecasting, by the one or more processor, a capacity demand in a timeframe on an IT resource of the one or more IT resources based on the information from the extracting;
selecting, by the one or more processor, an optimal procurement solution for an item of the IT resource that satisfies the capacity demand; and
producing, by the one or more processor, an optimized IT portfolio comprising the item of the IT resource and the optimal procurement solution.

2. The computer implemented method of claim 1, further comprising:
recording, in an IT portfolio, the information on the one or more IT services and the information on respective resources corresponding to each of the one or more IT services, subsequent to the extracting.

3. The computer implemented method of claim 1, further comprising:
formatting, by the one or more processor, the information on an IT service of the one or more IT service according to elements for the IT service predefined in an IT portfolio ontology; and
formatting, by the one or more processor, the information on an IT resource of the one or more IT resources according to element for the IT resource predefined in the IT portfolio ontology.

4. The computer implemented method of claim 1, further comprising:
converting the inputs into a standard language selected by an IT service provider that runs the one or more IT service systems, based on an IT portfolio ontology prescribing respective elements for the one or more IT services and respective elements for the one or more IT resources, by use of natural language processing tools.

5. The computer implemented method of claim 1, further comprising:
compiling, prior to the selecting, all available procurement solution for the item of the IT resource meeting the capacity demand from the forecasting based on multiple specifications by one or more IT resource supplier of the IT resource.

6. The computer implemented method of claim 1, further comprising:
updating, subsequent to the producing, an IT portfolio with the optimized IT portfolio; and
adding the optimized IT portfolio to an optimization history for training a machine learning model on the capacity demand in the forecasting.

7. The computer implemented method of claim 6, further comprising:
removing the optimized IT portfolio from the optimization history based on that the IT service system implemented by the optimized IT portfolio performs worse than a preconfigured performance threshold.

8. A computer program product comprising:
a computer readable storage medium readable by one or more processor and storing instructions for execution by the one or more processor for performing a method comprising:
collecting inputs from one or more information technology (IT) service systems, wherein the inputs comprise one or more service level agreements (SLAs), one or more SLA invoices corresponding to the one or more SLAs, one or more underpinning contracts (UCs), and one or more UC invoices;
extracting information on one or more IT services and one or more IT resources corresponding to an IT service of the one or more IT services from the inputs, wherein an IT service system of the one or more IT service systems provisions the IT service to an IT client by using the one or more IT resources;
forecasting a capacity demand in a timeframe on an IT resource of the one or more IT resources based on the information from the extracting;
selecting an optimal procurement solution for an item of the IT resource that satisfies the capacity demand; and
producing an optimized IT portfolio comprising the item of the IT resource and the optimal procurement solution.

9. The computer program product of claim 8, further comprising:
recording, in an IT portfolio, the information on the one or more IT services and the information on respective resources corresponding to each of the one or more IT services, subsequent to the extracting.

10. The computer program product of claim 8, further comprising:
formatting, by the one or more processor, the information on an IT service of the one or more IT service according to elements for the IT service predefined in an IT portfolio ontology; and
formatting, by the one or more processor, the information on an IT resource of the one or more IT resources according to element for the IT resource predefined in the IT portfolio ontology.

11. The computer program product of claim 8, further comprising:
converting the inputs into a standard language selected by an IT service provider that runs the one or more IT service systems, based on an IT portfolio ontology prescribing respective elements for the one or more IT services and respective elements for the one or more IT resources, by use of natural language processing tools.

12. The computer program product of claim 8, further comprising:
compiling, prior to the selecting, all available procurement solution for the item of the IT resource meeting the capacity demand from the forecasting based on multiple specifications by one or more IT resource supplier of the IT resource.

13. The computer program product of claim 8, further comprising:
updating, subsequent to the producing, an IT portfolio with the optimized IT portfolio; and
adding the optimized IT portfolio to an optimization history for training a machine learning model on the capacity demand in the forecasting.

14. The computer program product of claim 13, further comprising:
removing the optimized IT portfolio from the optimization history based on that the IT service system implemented by the optimized IT portfolio performs worse than a preconfigured performance threshold.

15. A system comprising:
a memory;
one or more processor in communication with memory; and
program instructions executable by the one or more processor via the memory to perform a method comprising:
collecting inputs from one or more information technology (IT) service systems, wherein the inputs comprise one or more service level agreements (SLAs), one or more SLA invoices corresponding to the one or more SLAs, one or more underpinning contracts (UCs), and one or more UC invoices;
extracting information on one or more IT services and one or more IT resources corresponding to an IT service of the one or more IT services from the inputs, wherein an IT service system of the one or more IT service systems provisions the IT service to an IT client by using the one or more IT resources;
forecasting a capacity demand in a timeframe on an IT resource of the one or more IT resources based on the information from the extracting;
selecting an optimal procurement solution for an item of the IT resource that satisfies the capacity demand; and
producing an optimized IT portfolio comprising the item of the IT resource and the optimal procurement solution.

16. The system of claim 15, further comprising:
recording, in an IT portfolio, the information on the one or more IT services and the information on respective resources corresponding to each of the one or more IT services, subsequent to the extracting.

17. The system of claim 15, further comprising:
formatting, by the one or more processor, the information on an IT service of the one or more IT service according to elements for the IT service predefined in an IT portfolio ontology; and
formatting, by the one or more processor, the information on an IT resource of the one or more IT resources according to element for the IT resource predefined in the IT portfolio ontology.

18. The system of claim 15, further comprising:
converting the inputs into a standard language selected by an IT service provider that runs the one or more IT service systems, based on an IT portfolio ontology prescribing respective elements for the one or more IT services and respective elements for the one or more IT resources, by use of natural language processing tools.

19. The system of claim 15, further comprising:
compiling, prior to the selecting, all available procurement solution for the item of the IT resource meeting the capacity demand from the forecasting based on multiple specifications by one or more IT resource supplier of the IT resource.

20. The system of claim 15, further comprising:
updating, subsequent to the producing, an IT portfolio with the optimized IT portfolio; and
adding the optimized IT portfolio to an optimization history for training a machine learning model on the capacity demand in the forecasting.
